(19) United States
(12) Patent Application Publication
(10) Pub. No.: US 2022/0136955 A1
(43) Pub. Date: May 5, 2022

(54) LASER PARTICLE SIZE ANALYZER WITH LIQUID SHEATH FLOW MEASURING CELL

(71) Applicant: LINKOPTIK INSTRUMENTS CO., LTD., Zhuhai (CN)

(72) Inventor: Fugen ZHANG, Zhuhai (CN)

(21) Appl. No.: 17/578,553

(22) Filed: Jan. 19, 2022

Related U.S. Application Data
(63) Continuation of application No. PCT/CN2020/096496, filed on Jun. 17, 2020.

(30) Foreign Application Priority Data
Jul. 31, 2019 (CN) 201910698536.8

(51) Int. Cl. G01N 15/14; G01N 15/02

(52) U.S. Cl. CPC G01N 15/1404; G01N 2021/052; G01N 15/0211

(57) ABSTRACT

A laser particle size analyzer with a liquid sheath flow measuring cell comprises a measuring cell which comprises a particle flow leading-in cavity (3000), a medium flow leading-in cavity (1000) and a measuring glass cavity (2000), wherein the medium flow leading-in cavity (1000) is connected to an upper portion of the measuring glass cavity (2000); the medium flow leading-in cavity (1000) is annularly arranged at a periphery of the particle flow leading-in cavity (3000), and a gap (607) is formed between the medium flow leading-in cavity (1000) and the particle flow leading-in cavity (3000); a medium flow (70) flows into the measuring glass cavity (2000) from the gap (607), and a particle flow (60) flows into the measuring glass cavity (2000) from the particle flow leading-in cavity (3000). The laser particle size analyzer achieves technical effects of long service life, simple operation and good use effect of the measuring cell.

### CROSS-REFERENCE TO RELATED APPLICATIONS

This application is a continuation of International Patent Application No. PCT/CN2020/096496 with a filing date of Jun. 17, 2020, designating the United States, now pending, and further claims priority to Chinese Patent Application No. 201910698536.8 with a filing date of Jul. 31, 2019. The content of the aforementioned applications, including any intervening amendments thereto, are incorporated herein by reference.

### TECHNICAL FIELD

The present invention relates to the field of particle test instrument technologies, and more particularly, to a laser particle size analyzer with a liquid sheath flow measuring cell.

### BACKGROUND

A laser particle size analyzer measures a particle size and distribution of particles by using a scattering (diffraction) phenomenon of particles to light, and during measuring, the measured particles should be dispersed in a liquid medium or a gas medium. Specifically. FIG. 1 is a classic principle diagram of measurement of particles suspended in a liquid, and a device for dispersing the measured particles is called “a measuring cell”, which is composed of glass 1 and glass 2 which are arranged at two sides, and a frame 3 and a frame 4 supporting the two pieces of glass respectively. A measured particle sample is a particle group composed of thousands of monomer particles, and in order to make measurement results more representative, the particles are often mixed with the liquid medium together at an appropriate concentration, and flow through the measuring cell above. A specific measurement principle is as follows: an arrow direction 5 in FIG. 1 represents a flow direction of particles or a particle flow, and parallel laser beams 6 pass through the glass 1 to be irradiated to the particle flow in the measuring cell, wherein if the laser beams encounter the particles, scattering may occur, scattered light passes through the glass 2 to be focused by a Fourier lens 7, and a detector array 8 is located on a focal plane of the Fourier lens 7. Therefore, the scattered light in the same direction is focused on the same position of the detector array 8. The detector array 8 is composed of dozens of detection units, each unit represents one scattering angle interval, and the detection units convert light signals projected on the detection units into electrical signals. Therefore, arrangement of the electrical signals outputted by the detector array 8 represents angular distribution of the scattered light, and a subsequent computer may inversely calculate particle size distribution of the measured particles according to distribution information of the scattered light. Moreover, the laser beams not scattered by the particles are focused on a small hole in a center of the detector array 8 by the Fourier lens 7, and the laser beams pass through the small hole to be received by a central detector 9 for detecting a concentration of the particles in the measuring cell.

Thus, it can be seen that, when the measured particles flow between the two pieces of glass 1 and glass 2 in the measuring cell, some fine or sticky particles may stick to inner walls of the glass 1 and the glass 2. Moreover, with increase of measuring times, more and more particles may stick to the inner walls of the glass 1 and the glass 2, so as to affect normal measurement. Therefore, at present, a wet measuring cell must be designed into a detachable and washable structure, and the inner walls of the glass 1 and the glass 2 should often be cleaned after testing for many times, with troublesome and time-consuming operation. In addition, the glass 1 and the glass 2 are remounted and reset after disassembly and cleaning, which may cause maladjustment of a whole optical system. Therefore, it is necessary to readjust the optical system again before re-measurement, which is extremely inconvenient to use and even shortens a service life of the measuring cell.

### SUMMARY

Aiming at the problems in the prior art, the present invention provides a laser particle size analyzer with a liquid sheath flow measuring cell, which solves technical problems of inconvenient operation caused by disassembly and cleaning of measuring glass of a measuring cell and maladjustment of an optical system after reset in the prior art, avoids the measuring cell from being polluted during measurement, and achieves technical effects of long service life, simple operation and good use effect of the measuring cell.

In order to achieve the object above, the present invention provides the following technical solutions.

A laser particle size analyzer with a liquid sheath flow measuring cell comprises a measuring cell, wherein the measuring cell comprises a particle flow leading-in cavity, a medium flow leading-in cavity and a measuring glass cavity, wherein the medium flow leading-in cavity is connected to an upper portion of the measuring glass cavity; the medium flow leading-in cavity is annularly arranged at a periphery of the particle flow leading-in cavity, and a gap is formed between the medium flow leading-in cavity and the particle flow leading-in cavity, a medium flow flows into the measuring glass cavity from the gap, and a particle flow flows into the measuring glass cavity from the particle flow leading-in cavity.

Further, an outlet of the particle flow leading-in cavity is inclined downwardly and narrowed relative to the particle flow leading-in cavity.

Further, the measuring cell further comprises a discharge pipe, and an outlet of the measuring glass cavity is communicated with the discharge pipe.

Further, the measuring cell further comprises a medium flow leading-in auxiliary cavity, an inlet of the medium flow leading-in cavity is accommodated in the medium flow leading-in auxiliary cavity, and an outlet of the medium flow leading-in cavity is communicated with an inlet of the measuring glass cavity; a side portion of the medium flow leading-in auxiliary cavity is provided with a medium leading-in opening, the medium leading-in opening is located below the inlet of the medium flow leading-in cavity, and the medium flow enters the medium flow leading-in auxiliary cavity from the medium leading-in opening; and an inlet of the particle flow leading-in cavity extends out of a top portion of the medium flow leading-in auxiliary cavity, and an outlet of the particle flow leading-in cavity extends into the measuring glass cavity.

Further, the inlet of the medium flow leading-in cavity is accommodated in the cavity above a middle portion of the medium flow leading-in auxiliary cavity.

Further, the medium flow leading-in cavity and the medium flow leading-in auxiliary cavity are integrally formed.

Further, the measuring glass cavity is set as a circular tubular glass pipe.

Further, the medium flow leading-in cavity is set as a circular tubular medium flow leading-in cavity, the particle flow leading-in cavity is set as a circular tubular particle flow leading-in cavity, and the medium flow leading-in auxiliary cavity is set as a circular tubular medium flow leading-in pipe.

Further, the measuring glass cavity comprises two pieces of flat glass arranged oppositely and a fixing frame for fixing the two pieces of flat glass.

Further, the medium flow leading-in cavity is set as a long circular tubular medium flow leading-in cavity, the particle flow leading-in cavity is set as a long circular tubular particle flow leading-in cavity, and the medium flow leading-in auxiliary cavity is set as a long circular tubular medium flow leading-in pipe.

The present invention has the beneficial effects as follows.

The laser particle size analyzer with the liquid sheath flow measuring cell provided by the present invention comprises the measuring cell, wherein the measuring cell comprises the particle flow leading-in cavity, the medium flow leading-in cavity and the measuring glass cavity, wherein the medium flow leading-in cavity is connected to the upper portion of the measuring glass cavity; the medium flow leading-in cavity is annularly arranged at the periphery of the particle flow leading-in cavity, and the gap is formed between the medium flow leading-in cavity and the particle flow leading-in cavity, the medium flow flows into the measuring glass cavity from the gap, and the particle flow flows into the measuring glass cavity from the particle flow leading-in cavity. For the laser particle size analyzer with the liquid sheath flow measuring cell above, the particle flow flows into the measuring glass cavity from the particle flow leading-in cavity, since the particle flow leading-in cavity penetrates into the medium flow leading-in cavity, during a process that the particle flow passes through the measuring glass cavity, the medium flow flows into the measuring glass cavity from the gap, and the medium flow forms a sheath flow around the particle flow with a uniform flow rate, which may ensure that the particle flow may not touch an inner wall surface of the measuring glass cavity during flowing and measurement, so as to keep the measuring glass cavity clean without disassembly and cleaning, and that is to say, during the process that the particle flow passes through the measuring glass cavity, two sides (periphery) are always wrapped by the clean medium flow, just like a knife wrapped by a sheath, so as to achieve an effect of protecting the measuring glass cavity from being polluted. The present invention provides the laser particle size analyzer with the liquid sheath flow measuring cell, which solves technical problems of inconvenient operation caused by disassembly and cleaning of measuring glass of the measuring cell and maladjustment of an optical system after reset in the prior art, avoids the measuring cell from being polluted during measurement, and achieves technical effects of long service life, simple operation and good use effect of the measuring cell.

### BRIEF DESCRIPTION OF THE DRAWINGS

FIG. 1 is a principle diagram of measurement of particles suspended in a liquid in the prior art;

FIG. 2 is a schematic diagram of a laser particle size analyzer with a liquid sheath flow measuring cell in Embodiment 1 of the present invention;

FIG. 3 is a schematic diagram of a laser particle size analyzer with a liquid sheath flow measuring cell in Embodiment 2 of the present invention;

FIG. 4 is a cross-sectional view of A-A in FIG. 3;

FIG. 5 is a cross-sectional view of B-B in FIG. 3;

FIG. 6 is a schematic diagram of a laser particle size analyzer with a liquid sheath flow measuring cell in Embodiment 3 of the present invention;

FIG. 7 is a cross-sectional view of A-A in FIG. 6; and

FIG. 8 is a cross-sectional view of B-B in FIG. 6.

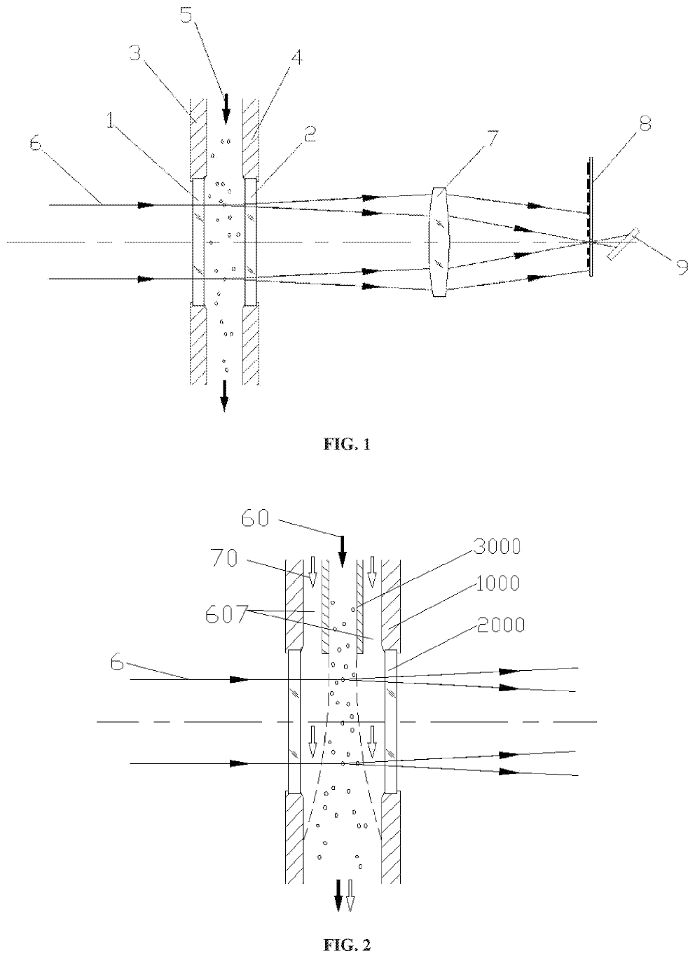

In the drawings, 1 refers to glass, 2 refers to glass, 3 refers to frame, 4 refers to frame, 5 refers to arrow direction. 6 refers to parallel laser beam, 7 refers to Fourier lens, 8 refers to detector array, 9 refers to central detector, 10/100/1000 refers to medium flow leading-in cavity, 11/110 refers to inlet, 12/120 refers to outlet, 20/200/2000 refers to measuring glass cavity, 21/210 refers to inlet, 22/220 refers to outlet, 23 refers to flat glass, 24 refers to flat glass, 30/300/3000 refers to particle flow leading-in cavity, 31/310 refers to inlet, 32/320 refers to outlet, 40/400 refers to medium flow leading-in auxiliary cavity, 41/410 refers to medium leading-in opening, 50/500 refers to discharge pipe, 60 refers to particle flow, 70 refers to medium flow, and 607 refers to gap.

### DETAILED DESCRIPTION

The technical solutions in the embodiments of the present invention are clearly and completely described with reference to the drawings in the embodiments of the present invention. Apparently, the described embodiments are only some but not all of the embodiments of the present invention. Based on the embodiments in the present invention, all other embodiments obtained by those of ordinary skills in the art without going through any creative work should fall within the scope of protection of the present invention.

### Embodiment 1

With reference to FIG. 2. FIG. 2 is a schematic diagram of a laser particle size analyzer with a liquid sheath flow measuring cell in Embodiment 1 of the present invention.

The laser particle size analyzer with the liquid sheath flow measuring cell provided by the present invention comprises a measuring cell. The measuring cell comprises a particle flow leading-in cavity 3000, a medium flow leading-in cavity 1000 and a measuring glass cavity 2000, wherein the medium flow leading-in cavity 1000 is connected to an upper portion of the measuring glass cavity 2000. The medium flow leading-in cavity 1000 is annularly arranged at a periphery of the particle flow leading-in cavity 3000, and a gap is formed between the medium flow leading-in cavity 1000 and the particle flow leading-in cavity 3000. A medium flow 70 flows into the measuring glass cavity 2000 from the gap, and a particle flow 60 flows into the measuring glass cavity 2000 from the particle flow leading-in cavity 3000.

For the laser particle size analyzer with the liquid sheath flow measuring cell above, the particle flow 60 flows into the measuring glass cavity 2000 from the particle flow leading-in cavity 3000. Since the particle flow leading-in cavity 3000 penetrates into the medium flow leading-in cavity 1000, while the particle flow 60 passes through the measuring glass cavity 2000, the medium flow 70 flows into the measuring glass cavity 2000 from the gap 607, a speed of the medium flow 70 is greater than that of the particle flow 60, and the medium flow 70 may form a sheath flow around the particle flow 60 with a uniform flow rate, which may ensure that the particle flow 60 may not touch an inner wall surface of the measuring glass cavity 2000 during flowing and measurement, so as to keep the measuring glass cavity clean without disassembly and cleaning, and that is to say, during the process that the particle flow 60 passes through the measuring glass cavity 2000, two sides (periphery) are always wrapped by the clean medium flow 70, just like a knife wrapped by a sheath, so as to achieve an effect of protecting the measuring glass cavity 2000 from being polluted.

In order to make the particle flow 60 better surrounded by the medium flow 70, the outlet of the particle flow leading-in cavity 3000 in the embodiment is inclined downwardly and narrowed relative to the particle flow leading-in cavity 3000, which further ensures that the particle flow 60 may not touch the inner wall surface of the measuring glass cavity 2000 during flowing and measurement.

In addition, after finishing the measurement, the particle flow 60 and the medium flow 70 above form a mixed flow. In order to facilitate discharge of the mixed flow, the measuring cell in the embodiment further comprises the discharge pipe, and the outlet of the measuring glass cavity 2000 is communicated with the discharge pipe. A structural form of the discharge pipe is not particularly limited, for example, the discharge pipe may be a funnel pipe or a circular pipe, preferably a hose, which facilitates adjustment of a discharge direction.

### Embodiment 2

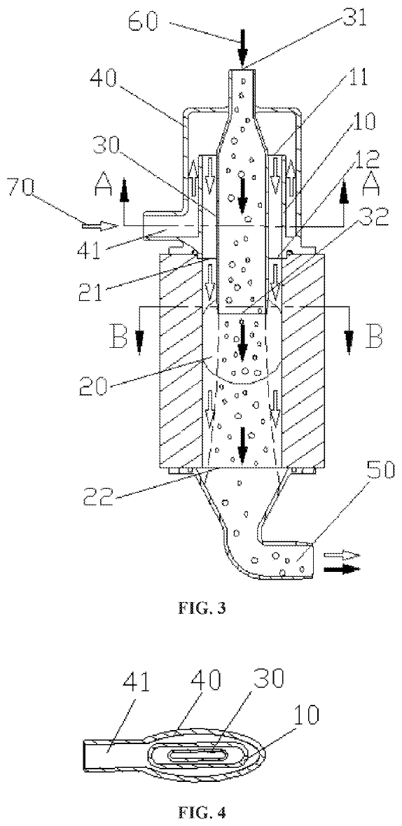

With reference to FIG. 3 to FIG. 5, FIG. 3 is a schematic diagram of a laser particle size analyzer with a liquid sheath flow measuring cell in Embodiment 2 of the present invention, FIG. 4 is a cross-sectional view of A-A in FIG. 3, and FIG. 5 is a cross-sectional view of B-B in FIG. 3.

The laser particle size analyzer with the liquid sheath flow measuring cell provided by the embodiment specifically refers to FIG. 3. The laser particle size analyzer with the liquid sheath flow measuring cell comprises a measuring cell. The measuring cell comprises a medium flow leading-in cavity 10, a measuring glass cavity 20, a particle flow leading-in cavity 30 and a medium flow leading-in auxiliary cavity 40. As shown in FIG. 3, an inlet 11 of the medium flow leading-in cavity 10 is accommodated in the medium flow leading-in auxiliary cavity 40. Preferably, the inlet 11 of the medium flow leading-in cavity 10 is accommodated above a middle portion of the medium flow leading-in auxiliary cavity 40, and an outlet 12 of the medium flow leading-in cavity 10 is communicated with an inlet 21 of the measuring glass cavity 20. A side portion of the medium flow leading-in auxiliary cavity 40 is provided with a medium leading-in opening 41, the medium leading-in opening 41 is located below the inlet 11 of the medium flow leading-in cavity 10, and a medium flow 70 enters the medium flow leading-in auxiliary cavity 40 from the medium leading-in opening 41 above. The particle flow leading-in cavity 30 penetrates into the medium flow leading-in cavity 10, an inlet 31 of the particle flow leading-in cavity 30 extends out of a top portion of the medium flow leading-in auxiliary cavity 40, an outlet 32 of the particle flow leading-in cavity 30 extends into the measuring glass cavity 20, and a particle flow 60 flows into the measuring glass cavity 20 from the particle flow leading-in cavity 30.

For the laser particle size analyzer with the liquid sheath flow measuring cell above, the medium flow 70 enters the medium flow leading-in auxiliary cavity 40 from the medium leading-in opening 41, and then flows upwardly along an outer wall of the medium flow leading-in cavity 10, until the medium flow flows to a top end of an outer wall of the medium flow leading-in cavity 10 or even a higher position. At the moment, the medium flow 70 flows downwardly into the medium flow leading-in cavity 10 from the inlet 11 of the medium flow leading-in cavity 10, and then flows into the measuring glass cavity 20. Moreover, the particle flow 60 flows into the measuring glass cavity 20 from the particle flow leading-in cavity 30. Since the particle flow leading-in cavity 30 penetrates into the medium flow leading-in cavity 10, while the particle flow 60 passes through the measuring glass cavity 20, the medium flow 70 also flows into the measuring glass cavity 20, a speed of the medium flow 70 is greater than that of the particle flow 60, and the medium flow 70 may form a sheath flow around the particle flow 60 with a uniform flow rate, which may ensure that the particle flow 60 may not touch an inner wall surface of the measuring glass cavity 20 during flowing and measurement, so as to keep the measuring glass cavity clean without disassembly and cleaning, and that is to say, during the process that the particle flow 60 passes through the measuring glass cavity 20, two sides (periphery) are always wrapped by the clean medium flow 70. The present invention provides the laser particle size analyzer with the liquid sheath flow measuring cell, which solves technical problems of inconvenient operation caused by disassembly and cleaning of measuring glass of the measuring cell and maladjustment of an optical system after reset in the prior art, avoids the measuring cell from being polluted during measurement, and achieves technical effects of long service life, simple operation and good use effect of the measuring cell.

In order to make the particle flow 60 better surrounded by the medium flow 70, the outlet 32 of the particle flow leading-in cavity 30 in the embodiment is inclined downwardly and narrowed relative to the particle flow leading-in cavity 30, which further ensures that the particle flow 60 may not touch the inner wall surface of the measuring glass cavity 20 during flowing and measurement.

In addition, in the embodiment, preferably, an inner diameter of the measuring glass cavity 20 is equal to an inner diameter of the medium flow leading-in cavity 10, so that the medium flow 70 smoothly flows into the measuring glass cavity 20 from the medium flow leading-in cavity 10, and it is convenient for the medium flow 70 to form a sheath flow around the particle flow 60 with a uniform flow rate, which further ensures that the particle flow 60 may not touch the inner wall surface of the measuring glass cavity 20 during flowing and measurement, so as to keep the measuring glass cavity clean without disassembly and cleaning.

Further preferably, in the embodiment, the medium flow leading-in auxiliary cavity 40 and the medium flow leading-in cavity 10 are integrally formed, which simplifies a processing technology.

With reference to FIG. 5, the measuring glass cavity 20 in the embodiment comprises two pieces of flat glass arranged oppositely, which are flat glass 23 and flat glass 24 respectively, and the measuring glass cavity 20 further comprises fixing frames for fixing the flat glass 23 and the flat glass 24, thus ensuring a measurement accuracy.

With reference to FIG. 4, correspondingly, the medium flow leading-in cavity 10 is set as a long circular tubular medium flow leading-in cavity, the particle flow leading-in cavity 30 is set as a long circular tubular particle flow leading-in cavity, and the medium flow leading-in auxiliary cavity 40 is set as a long circular tubular medium flow leading-in pipe, thus being convenient for the medium flow 70 to form the sheath flow around the particle flow 60 with the uniform flow rate, and further ensuring that the particle flow 60 may not touch the inner wall surface of the measuring glass cavity 20 during flowing and measurement.

In addition, after finishing the measurement, the particle flow 60 and the medium flow 70 above form a mixed flow. In order to facilitate discharge of the mixed flow, the measuring cell in the embodiment further comprises the discharge pipe 50, and the outlet 22 of the measuring glass cavity 20 is communicated with the discharge pipe 50. A structural form of the discharge pipe 50 is not particularly limited, for example, the discharge pipe may be a funnel pipe or a circular pipe, preferably a hose, which facilitates adjustment of a discharge direction.

### Embodiment 3

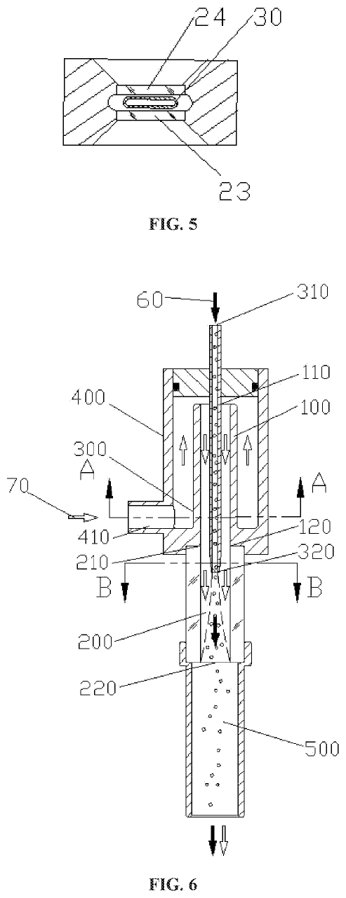

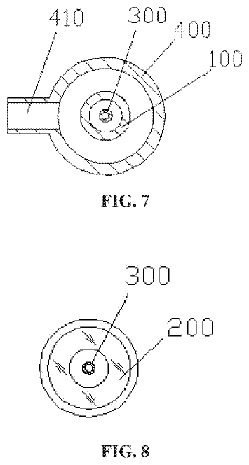

With reference to FIG. 6 to FIG. 8, FIG. 6 is a schematic diagram of a laser particle size analyzer with a liquid sheath flow measuring cell in Embodiment 3 of the present invention, FIG. 7 is a cross-sectional view of A-A in FIG. 6, and FIG. 8 is a cross-sectional view of B-B in FIG. 6.

With reference to FIG. 6, the laser particle size analyzer with the liquid sheath flow measuring cell comprises a measuring cell. The measuring cell comprises a medium flow leading-in cavity 100, a measuring glass cavity 200, a particle flow leading-in cavity 300 and a medium flow leading-in auxiliary cavity 400. As shown in FIG. 6, an inlet 110 of the medium flow leading-in cavity 100 is accommodated in the medium flow leading-in auxiliary cavity 400. Preferably, the inlet 110 of the medium flow leading-in cavity 100 is accommodated above a middle portion of the medium flow leading-in auxiliary cavity 400, and an outlet 120 of the medium flow leading-in cavity 100 is communicated with an inlet 210 of the measuring glass cavity 200. A side portion of the medium flow leading-in auxiliary cavity 400 is provided with a medium leading-in opening 410, the medium leading-in opening 410 is located below the inlet 110 of the medium flow leading-in cavity 100, and a medium flow 70 enters the medium flow leading-in auxiliary cavity 400 from the medium leading-in opening 410 above. The particle flow leading-in cavity 300 penetrates into the medium flow leading-in cavity 100, an inlet 310 of the particle flow leading-in cavity 300 extends out of a top portion of the medium flow leading-in auxiliary cavity 400, an outlet 320 of the particle flow leading-in cavity 300 extends into the measuring glass cavity 200, and a particle flow 60 flows into the measuring glass cavity 200 from the particle flow leading-in cavity 300.

For the laser particle size analyzer with the liquid sheath flow measuring cell above, the medium flow 70 enters the medium flow leading-in auxiliary cavity 400 from the medium leading-in opening 410, and then flows upwardly along an outer wall of the medium flow leading-in cavity 100, until the medium flow flows to a top end of an outer wall of the medium flow leading-in cavity 100 or even a higher position. At the moment, the medium flow 70 flows downwardly into the medium flow leading-in cavity 100 from the inlet 110 of the medium flow leading-in cavity 100, and then flows into the measuring glass cavity 200. Moreover, the particle flow 60 flows into the measuring glass cavity 200 from the particle flow leading-in cavity 300. Since the particle flow leading-in cavity 300 penetrates into the medium flow leading-in cavity 100, while the particle flow 60 passes through the measuring glass cavity 200, the medium flow 70 also flows into the measuring glass cavity 200, a speed of the medium flow 70 is greater than that of the particle flow 60, and the medium flow 70 may form a sheath flow around the particle flow 60 with a uniform flow rate, which may ensure that the particle flow 60 may not touch an inner wall surface of the measuring glass cavity 200 during flowing and measurement, so as to keep the measuring glass cavity clean without disassembly and cleaning, and that is to say, during the process that the particle flow 60 passes through the measuring glass cavity 200, two sides (periphery) are always wrapped by the clean medium flow 70, just like a knife wrapped by a sheath, so as to achieve an effect of protecting the measuring glass cavity 200 from being polluted. The present invention provides the laser particle size analyzer with the liquid sheath flow measuring cell, which solves technical problems of inconvenient operation caused by disassembly and cleaning of measuring glass of the measuring cell and maladjustment of an optical system after reset in the prior art, avoids the measuring cell from being polluted during measurement, and achieves technical effects of long service life, simple operation and good use effect of the measuring cell.

The embodiment is different from the embodiments above as follows.

With reference to FIG. 8, the measuring glass cavity 200 in the embodiment is set as a circular tubular glass pipe, which is namely a circular glass pipe, with a simple structure, a stable performance, and a good effect especially on measurement of sub-micron particles.

With reference to FIG. 7, correspondingly, the medium flow leading-in cavity 100 is set as a circular tubular medium flow leading-in cavity, the particle flow leading-in cavity 300 is set as a circular tubular particle flow leading-in cavity, and the medium flow leading-in auxiliary cavity 400 is set as a circular tubular medium flow leading-in pipe, thus being convenient for the medium flow 70 to form the sheath flow around the particle flow 60 with the uniform flow rate, and further ensuring that the particle flow 60 may not touch the inner wall surface of the measuring glass cavity 20 during flowing and measurement.

Other contents with the same principle as those of the embodiments above will not be repeated.

The embodiments above are only used to illustrate the technical solutions of the present invention, and are not intended to limit the present invention. The present invention is described in detail with reference to the preferred embodiments. Those skilled in the art should understand that modifications or equivalent replacements made on the technical solutions of the present invention without deviating from the purpose and scope of the technical solutions of the present invention should be included within the scope of the claims of the present invention.

1. A laser particle size analyzer with a liquid sheath flow measuring cell, comprising a measuring cell, wherein: the measuring cell comprises a particle flow leading-in cavity, a medium flow leading-in cavity and a measuring glass cavity, wherein the medium flow leading-in cavity is connected to an upper portion of the measuring glass cavity; the medium flow leading-in cavity is annularly arranged at a periphery of the particle flow leading-in cavity, and a gap is formed between the medium flow leading-in cavity and the particle flow leading-in cavity, a medium flow flows into the measuring glass cavity from the gap, and a particle flow flows into the measuring glass cavity from the particle flow leading-in cavity.

2. The laser particle size analyzer with the liquid sheath flow measuring cell according to claim 1, wherein an outlet of the particle flow leading-in cavity is inclined downwardly and narrowed relative to the particle flow leading-in cavity.

3. The laser particle size analyzer with the liquid sheath flow measuring cell according to claim 1, wherein the measuring cell further comprises a discharge pipe, and an outlet of the measuring glass cavity is communicated with the discharge pipe.

4. The laser particle size analyzer with the liquid sheath flow measuring cell according to claim 1, wherein the measuring cell further comprises a medium flow leading-in auxiliary cavity, an inlet of the medium flow leading-in cavity is accommodated in the medium flow leading-in auxiliary cavity, and an outlet of the medium flow leading-in cavity is communicated with an inlet of the measuring glass cavity; a side portion of the medium flow leading-in auxiliary cavity is provided with a medium leading-in opening, the medium leading-in opening is located below the inlet of the medium flow leading-in cavity, and the medium flow enters the medium flow leading-in auxiliary cavity from the medium leading-in opening; and an inlet of the particle flow leading-in cavity extends out of a top portion of the medium flow leading-in auxiliary cavity, and an outlet of the particle flow leading-in cavity extends into the measuring glass cavity.

5. The laser particle size analyzer with the liquid sheath flow measuring cell according to claim 4, wherein the inlet of the medium flow leading-in cavity is accommodated in the cavity above a middle portion of the medium flow leading-in auxiliary cavity.

6. The laser particle size analyzer with the liquid sheath flow measuring cell according to claim 4, wherein the medium flow leading-in cavity and the medium flow leading-in auxiliary cavity are integrally formed.

7. The laser particle size analyzer with the liquid sheath flow measuring cell according to claim 1, wherein the measuring glass cavity is set as a circular tubular glass pipe.

8. The laser particle size analyzer with the liquid sheath flow measuring cell according to claim 7, wherein the medium flow leading-in cavity is set as a circular tubular medium flow leading-in cavity, the particle flow leading-in cavity is set as a circular tubular particle flow leading-in cavity, and the medium flow leading-in auxiliary cavity is set as a circular tubular medium flow leading-in pipe.

9. The laser particle size analyzer with the liquid sheath flow measuring cell according to claim 1, wherein the measuring glass cavity comprises two pieces of flat glass arranged oppositely and a fixing frame for fixing the two pieces of flat glass.

10. The laser particle size analyzer with the liquid sheath flow measuring cell according to claim 9, wherein the medium flow leading-in cavity is set as a long circular tubular medium flow leading-in cavity, the particle flow leading-in cavity is set as a long circular tubular particle flow leading-in cavity, and the medium flow leading-in auxiliary cavity is set as a long circular tubular medium flow leading-in pipe.
